(19) United States
(12) Patent Application Publication
(10) Pub. No.: US 2023/0264329 A1
(43) Pub. Date: Aug. 24, 2023

(54) CV AXLE REMOVING DEVICE

(71) Applicant: Doyle Turner, Epps, LA (US)

(72) Inventor: Doyle Turner, Epps, LA (US)

(21) Appl. No.: 17/677,470

(22) Filed: Feb. 22, 2022

(51) Int. Cl. B25B 27/00

(52) U.S. Cl. CPC B25B 27/0035

(57) ABSTRACT

A CV axle removing device, including a main body, including a first section to receive at least a portion of a CV axle therein, and a second section removably connected to at least a portion of the first section to receive at least a portion of the CV axle, such that the CV axle is disposed between the first section and the second section, and an attachment plate removably connected to at least a portion of at least one of an inner joint and an outer joint of the CV axle to receive at least a portion of a slide hammer therein.

### BACKGROUND

### 1. Field

The present general inventive concept relates generally to vehicle repairs, and particularly, to a CV axle removing device.

### 2. Description of the Related Art

A constant velocity (CV) axle for a vehicle plays a vital role in keeping the vehicle running, but it can get stuck in a transmission, a hub, and/or a differential creating a problematic situation for a driver. Unfortunately, when the axle is stuck inside the hub, it can be incredibly difficult, time-consuming, and/or tedious to remove it for replacement, and will often warrant a costly trip to a vehicle repair location.

Most people are unaware of alternatives for vehicle repair leaving them at the mercy of the vehicle repair location.

Therefore, there is a need for a CV axle removing device to facilitate removal of the CV axle.

### SUMMARY

The present general inventive concept provides a CV axle removing device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a CV axle removing device, including a main body, including a first section to receive at least a portion of a CV axle therein, and a second section removably connected to at least a portion of the first section to receive at least a portion of the CV axle, such that the CV axle is disposed between the first section and the second section, and an attachment plate removably connected to at least a portion of at least one of an inner joint an an outer joint of the CV axle to receive at least a portion of a slide hammer therein.

The first section may include a first curved body having an arcuate shape, a first attachment surface disposed on at least a portion of a first end of the first curved body to extend away from the first curved body with respect to a first direction, a second attachment surface disposed on at least a portion of a second end of the first curved body to extend away from the first curved body with respect to a second direction opposite to the first direction, and a first half base disposed on at least a portion of an edge of the first curved body between the first attachment surface and the second attachment surface to form a curved planar surface.

The first half base may have an arcuate shape corresponding to the arcuate shape of the first curved body.

The second section may include a second curved body having an arcuate shape, a first attachment surface disposed on at least a portion of a first end of the second curved body to extend away from the second curved body with respect to a first direction, a second attachment surface disposed on at least a portion of a second end of the second curved body to extend away from the second curved body with respect to a second direction opposite to the first direction, and a second half base disposed on at least a portion of an edge of the second curved body between the first attachment surface and the second attachment surface to form a curved planar surface.

The second half base may have an arcuate shape corresponding to the arcuate shape of the second curved body.

The attachment plate may include a plate body to removably connect to at least a portion of the first section and the second section, a hammer receiving aperture disposed on at least a portion of a center of the plate body to receive at least a portion of the slide hammer therein, a first fastener receiving aperture disposed within at least a portion of a first end of the plate body, and a second fastener receiving aperture disposed within at least a portion of a second end of the plate body opposite with respect to the first end.

The CV axle removing device may further include a plurality of section fasteners to removably connect the first section to the second section.

The CV axle removing device may further include a plurality of connecting fasteners welded to at least a portion of the second section to receive at least one of the plurality of section fasteners therein.

The CV axle removing device may further include a plurality of fastener receiving edges disposed on at least a portion of the first section and the second section to protrude away from the first section and the second section.

The CV axle removing device may further include a plurality of edge fasteners disposed on at least a portion of the plurality of fastener receiving edges, and a plurality of plate connecting fasteners to removably connect to the plurality of edge fasteners through the attachment plate.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a CV axle removing device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

CV Axle Removing Device 100

Main Body 110

First Section 111

First Curved Body 111a

First Attachment Surface 111b

Second Attachment Surface 111c

First Half Base 111d

Second Section 112

Second Curved Body 112a

First Attachment Surface 112b

Second Attachment Surface 112c

Second Half Base 112d

Attachment Plate 120

Plate Body 121

Hammer Receiving Aperture 122

First Fastener Receiving Aperture 123

Second Fastener Receiving Aperture 124

Section Fasteners 130

Connecting Fasteners 140

Fastener Receiving Edges 150

Edge Fasteners 160

Plate Connecting Fasteners 170

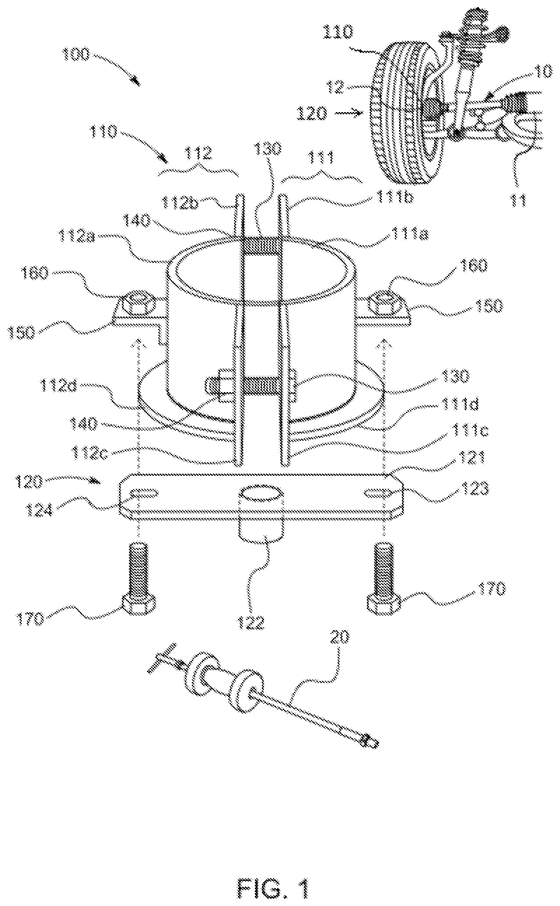

FIG. 1 illustrates a side perspective view of a CV axle removing device 100, according to an exemplary embodiment of the present general inventive concept.

The CV axle removing device 100 may be constructed from at least one of metal, plastic, wood, and rubber, etc., but is not limited thereto.

The CV axle removing device 100 may include a main body 110, an attachment plate 120, a plurality of section fasteners 130, a plurality of connecting fasteners 140, a plurality of fastener receiving edges 150, a plurality of edge fasteners 160, and a plurality of plate connecting fasteners 170, but is not limited thereto.

The main body 110 may include a first section 111 and a second section 112, but is not limited thereto.

Referring to FIG. 1, the main body 110 is illustrated to have a cylindrical shape. However, the main body 110 may be rectangular, circular, conical, triangular, pentagonal, hexagonal, heptagonal, octagonal, or any other shape known to one of ordinary skill in the art, but is not limited thereto.

The first section 111 may include a first curved body 111a, a first attachment surface 111b, a second attachment surface 111c, and a first half base 111d, but is not limited thereto.

The first curved body 111a may have an arcuate shape, such that the first curved body 111a may be concave shaped with respect to a first side of the first curved body 111a and convex shaped with respect to a second side opposite with respect to the first side of the first curved body 111a. Moreover, the first curved body 111a may receive and/or removably connect to at least a portion of a constant velocity (CV) axle 10. Also, the first side of the first curved body 111a may have a cushioned surface disposed thereon to absorb an impact thereto and/or be a textured surface to prevent the first curved body 111a from lateral movement (e.g., slipping) along the CV axle 10.

The first attachment surface 111b may be disposed on at least a portion of a first end of the first curved body 111a. The first attachment surface 111b may extend away from the first curved body 111a with respect to a first direction.

The second attachment surface 111c may be disposed on at least a portion of a second end of the first curved body 111a. The second attachment surface 111c may extend away from the first curved body 111a with respect to a second direction opposite to the first direction.

The first half base 111d may be disposed on at least a portion of an edge of the first curved body 111a between the first attachment surface 111b and/or the second attachment surface 111c. Additionally, the first half base 111d may be perpendicularly disposed away from the first curved body 111a, such that the first half base 111d forms a curved planar surface. As such, the first half base 111d may have an arcuate shape corresponding to the arcuate shape of the first curved body 111a.

The second section 112 may include a second curved body 112a, a first attachment surface 112b, a second attachment surface 112c, and a second half base 112d, but is not limited thereto.

The second curved body 112a may have an arcuate shape, such that the second curved body 112a may be concave shaped with respect to a first side of the second curved body 112a and convex shaped with respect to a second side opposite with respect to the first side of the second curved body 112a. Moreover, the second curved body 112a may receive and/or removably connect to at least a portion of the CV axle 10. Also, the first side of the second curved body 112a may have a cushioned surface disposed thereon to absorb an impact thereto and/or be a textured surface to prevent the second curved body 112a from lateral movement (e.g., slipping) along the CV axle 10.

The first attachment surface 112b may be disposed on at least a portion of a first end of the second curved body 112a. The first attachment surface 112b may extend away from the second curved body 112a with respect to a first direction.

The second attachment surface 112c may be disposed on at least a portion of a second end of the second curved body 112a. The second attachment surface 112c may extend away from the second curved body 112a with respect to a second direction opposite to the first direction.

The second half base 112d may be disposed on at least a portion of an edge of the second curved body 112a between the first attachment surface 112b and/or the second attachment surface 112c. Additionally, the second half base 112d may be perpendicularly disposed away from the second curved body 111a, such that the second half base 112d forms a curved planar surface. As such, the second half base 112d may have an arcuate shape corresponding to the arcuate shape of the second curved body 112a.

Therefore, the first curved body 111a and/or the second curved body 112a collectively form a cylindrical shape. Similarly, the first half base 111d and/or the second half base 112 collectively form a circle.

The attachment plate 120 may include a plate body 121, a hammer receiving aperture 122, a first fastener receiving aperture 123, a second fastener receiving aperture 124, but is not limited thereto.

Referring again to FIG. 1, the plate body 121 is illustrated to have a rounded rectangular shape. However, the plate body 121 may be rectangular, cylindrical, pentagonal, hexagonal, octagonal, or any other shape known to one of ordinary skill in the art, but is not limited thereto.

The plate body 121 may be removably connected to at least a portion of the first half base 111d and/or the second half base 112d, and an inner joint 11 and/or an outer joint 12 of the CV axle 10. Alternatively, the plate body 121 may be disposed such that the inner joint 11 and/or the outer joint 12 of the CV axle 10 is disposed between the plate body 121 and/or the first half base 111d and/or the second half base 112d.

The hammer receiving aperture 122 may be disposed on at least a portion of a center of the plate body 121. The hammer receiving aperture 122 may receive at least a portion of a slide hammer 20 therein. As such, the hammer receiving aperture 122 may connect to the slide hammer 20 therein. Thus, the hammer receiving aperture 122 may facilitate extraction of the CV axle 10 using the slide hammer 20. Also, the hammer receiving aperture 122 may perpendicularly extend away from the plate body 121 with respect to a direction.

The first fastener receiving aperture 123 may be disposed within at least a portion of a first end of the plate body 121.

The second fastener receiving aperture 124 may be disposed within at least a portion of a second end of the plate body 122 opposite with respect to the first end.

Referring again to FIG. 1, each of the plurality of section fasteners 130 is illustrated to be a bolt. However, each of the plurality of section fasteners 130 may be a nail, a rivet, a screw, a magnet, and/or any combination thereof, but is not limited thereto.

Each of the plurality of section fasteners 130 may be inserted into a section aperture disposed on the first attachment surface 111b and/or the second attachment surface 111c toward the first attachment surface 112b and/or the second attachment surface 112c. As such, the plurality of section fasteners 130 may connect the first attachment surface 111b and/or the second attachment surface 111c to the first attachment surfaced 112b and/or the second attachment surface 112c, respectively. Accordingly, the plurality of section fasteners 130 may prevent the first curved body 111a and/or the second curved body 112a from moving along the CV axle 10 while disposed around the CV axle 10.

Referring again to FIG. 1, each of the plurality of connecting fasteners 140 is illustrated to be a nut. However, each of the plurality of connecting fasteners 140 may be a washer, an anchor, a retaining ring, a magnet, and/or any combination thereof, but is not limited thereto.

Each of the plurality of connecting fasteners 140 may be disposed on at least a portion of the first attachment surface 112b and/or the second attachment surface 112c. More specifically, the plurality of connecting fasteners 140 may be welded to the first attachment surface 112b and/or the second attachment surface 112c. Each of the plurality of connecting fasteners 140 may receive and/or removably connect to at least a portion of at least one of the plurality of section fasteners 130.

Each of the plurality of fastener receiving edges 150 may be disposed on at least a portion of the first curved body 111a and/or the second curved body 112a. Moreover, each of the plurality of fastener receiving edges 150 may protrude away from the first curved body 111a and/or the second curved body 112a.

Referring again to FIG. 1, each of the plurality of edge fasteners 160 is illustrated to be a nut. However, each of the plurality of edge fasteners 160 may be a washer, an anchor, a retaining ring, a magnet, and/or any combination thereof, but is not limited thereto.

Each of the plurality of edge fasteners 160 may be disposed on at least a portion of a first of the plurality of fastener receiving edges 150 and/or a second of the plurality of fastener receiving edges 150, such that each of the plurality of fastener receiving edges 150 may have an edge aperture therethrough.

Referring again to FIG. 1, each of the plurality of plate connecting fasteners 170 is illustrated to be a bolt. However, each of the plurality of plate connecting fasteners 170 may be a nail, a rivet, a screw, a magnet, and/or any combination thereof, but is not limited thereto.

Each of the plurality of plate connecting fasteners 170 may be inserted into the first fastener receiving aperture 123 and/or the second fastener receiving aperture 124 toward the edge aperture disposed on the plurality of fastener receiving edges 150 to connect to at least one of the plurality of edge fasteners 160. As such, the plurality of plate connecting fasteners 170 may connect the plate body 121 to the first half base 111d and/or the second half base 112d. Accordingly, the plurality of plate connecting fasteners 170 may prevent the plate body 121 from moving away from the first half base 111d and/or the second half base 112 while connected to the plurality of edge fasteners 160.

Therefore, the CV axle removing device 100 may facilitate removal of the CV axle 10 using the slide hammer 20 without extensive labor and/or complexity from a vehicle repair shop. Also, the CV axle removing device 100 may reduce time for removal of the CV axle 10 from three hours to a fifteen-minute process.

The present general inventive concept may include a CV axle removing device 100, including a main body 110, including a first section 111 to receive at least a portion of a CV axle 10 therein, and a second section 112 removably connected to at least a portion of the first section 111 to receive at least a portion of the CV axle 10, such that the CV axle 10 is disposed between the first section 111 and the second section 112, and an attachment plate 120 removably connected to at least a portion of at least one of an inner joint 11 and an outer joint 12 of the CV axle 10 to receive at least a portion of a slide hammer 20 therein.

The first section 111 may include a first curved body 111a having an arcuate shape, a first attachment surface 111b disposed on at least a portion of a first end of the first curved body 111a to extend away from the first curved body 111a with respect to a first direction, a second attachment surface 111c disposed on at least a portion of a second end of the first curved body 111a to extend away from the first curved body 111a with respect to a second direction opposite to the first direction, and a first half base 111d disposed on at least a portion of an edge of the first curved body 111a between the first attachment surface 111b and the second attachment surface 111c to form a curved planar surface.

The first half base 111d may have an arcuate shape corresponding to the arcuate shape of the first curved body 111a.

The second section 112 may include a second curved body 112a having an arcuate shape, a first attachment surface 112b disposed on at least a portion of a first end of the second curved body 112a to extend away from the second curved body 112a with respect to a first direction, a second attachment surface 112c disposed on at least a portion of a second end of the second curved body 112a to extend away from the second curved body 112a with respect to a second direction opposite to the first direction, and a second half base 112d disposed on at least a portion of an edge of the second curved body 112a between the first attachment surface 112b and the second attachment surface 112c to form a curved planar surface.

The second half base 112d may have an arcuate shape corresponding to the arcuate shape of the second curved body 112a.

The attachment plate 120 may include a plate body 121 to removably connect to at least a portion of the first section 111 and the second section 112, a hammer receiving aperture 122 disposed on at least a portion of a center of the plate body 121 to receive at least a portion of the slide hammer 20 therein, a first fastener receiving aperture 123 disposed within at least a portion of a first end of the plate body 121, and a second fastener receiving aperture 124 disposed within at least a portion of a second end of the plate body 121 opposite with respect to the first end.

The CV axle removing device 100 may further include a plurality of section fasteners 130 to removably connect the first section 111 to the second section 112.

The CV axle removing device 100 may further include a plurality of connecting fasteners 140 welded to at least a portion of the second section 112 to receive at least one of the plurality of section fasteners 130 therein.

The CV axle removing device 100 may further include a plurality of fastener receiving edges 150 disposed on at least a portion of the first section 111 and the second section 112 to protrude away from the first section 111 and the second section 112.

The CV axle removing device 100 may further include a plurality of edge fasteners 160 disposed on at least a portion of the plurality of fastener receiving edges 150, and a plurality of plate connecting fasteners 170 to removably connect to the plurality of edge fasteners 160 through the attachment plate 120.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A CV axle removing device, comprising:
a main body, comprising:
a first section to receive at least a portion of a CV axle therein, and
a second section removably connected to at least a portion of the first section to receive at least a portion of the CV axle, such that the CV axle is received through a first end of the first section and a first end of the second section, and disposed between the first section and the second section;
a plurality of fastener receiving edges disposed on at least a portion of the first section and the second section to protrude away from the first section and the second section, such that a first of the plurality of fastener receiving edges is disposed only on the first section and protrudes away from the first section in a first direction, and a second of the plurality of fastener receiving edges is disposed only on the second section and protrudes away from the second section in a second direction opposite with respect to the first direction; and
an attachment plate removably connected to a second end of the first section and a second end of the second section and configured to be removably connected to at least a portion of at least one of an inner joint and an outer joint of the CV axle to receive at least a portion of a slide hammer therein, such that the attachment plate is connected to the plurality of fastener receiving edges at a distance away from the plurality of fastener receiving edges.

2. The CV axle removing device of claim 1, wherein the first section comprises:
a first curved body having an arcuate shape;
a first attachment surface disposed on at least a portion of a first end of the first curved body to extend away from the first curved body with respect to a first direction;
a second attachment surface disposed on at least a portion of a second end of the first curved body to extend away from the first curved body with respect to a second direction opposite to the first direction; and
a first half base disposed on at least a portion of an edge of the first curved body between the first attachment surface and the second attachment surface to form a curved planar surface.

3. The CV axle removing device of claim 2, wherein the first half base has an arcuate shape corresponding to the arcuate shape of the first curved body.

4. The CV axle removing device of claim 1, wherein the second section comprises:
a second curved body having an arcuate shape;
a first attachment surface disposed on at least a portion of a first end of the second curved body to extend away from the second curved body with respect to a first direction;
a second attachment surface disposed on at least a portion of a second end of the second curved body to extend away from the second curved body with respect to a second direction opposite to the first direction; and
a second half base disposed on at least a portion of an edge of the second curved body between the first attachment surface and the second attachment surface to form a curved planar surface.

5. The CV axle removing device of claim 4, wherein the second half base has an arcuate shape corresponding to the arcuate shape of the second curved body.

6. The CV axle removing device of claim 1, wherein the attachment plate comprises:
a plate body to removably connect to at least a portion of the first section and the second section;
a hammer receiving aperture disposed on at least a portion of a center of the plate body to receive at least a portion of the slide hammer therein;
a first fastener receiving aperture disposed within at least a portion of a first end of the plate body; and
a second fastener receiving aperture disposed within at least a portion of a second end of the plate body opposite with respect to the first end.

7. The CV axle removing device of claim 1, further comprising:
a plurality of section fasteners to removably connect the first section to the second section.

8. The CV axle removing device of claim 7, further comprising:
a plurality of connecting fasteners welded to at least a portion of the second section to receive at least one of the plurality of section fasteners therein.

9. (canceled)

10. The CV axle removing device of claim 9, further comprising:
a plurality of edge fasteners disposed on at least a portion of the plurality of fastener receiving edges; and
a plurality of plate connecting fasteners to removably connect to the plurality of edge fasteners through the attachment plate.

11. A CV axle removing device, comprising:
a main body, comprising:
a first section to receive at least a portion of a CV axle therein, and
a second section removably connected to at least a portion of the first section to receive at least a portion of the CV axle, such that the CV axle is disposed between the first section and the second section;
a plurality of fastener receiving edges disposed on at least a portion of the first section and the second section to protrude away from the first section and the second section, such that a first of the plurality of fastener receiving edges is disposed only on the first section and protrudes away from the first section in a first direction, and a second of the plurality of fastener receiving edges is disposed only on the second section and protrudes away from the second section in a second direction opposite with respect to the first direction;
a plurality of section fasteners to removably connect a first attachment surface of the first section to a first attachment surface of the second section, and removably connect a second attachment surface of the first section to a second attachment surface of the second section, such that each of the plurality of section fasteners are angularly disposed between two of the plurality of fastener receiving edges; and
an attachment plate fastened to the first section and a second section, and configured to be removably connected to at least a portion of at least one of an inner joint and an outer joint of the CV axle to receive at least a portion of a slide hammer therein.
